(19) United States
(12) Patent Application Publication
(10) Pub. No.: US 2026/0196894 A1
(43) Pub. Date: Jul. 9, 2026

(54) PERMANENT MAGNET MOTORS WITH FLUX FOUNTAIN OUTRUNNER

(71) Applicant: Niron Magnetics, Inc., Minneapolis, MN (US)

(72) Inventor: Anthony C. Morcos, Raleigh, NC (US)

(21) Appl. No.: 19/441,107

(22) Filed: Jan. 6, 2026

Related U.S. Application Data
(60) Provisional application No. 63/743,441, filed on Jan. 9, 2025.

(51) Int. Cl. H02K 1/2791; H02K 1/02

(52) U.S. Cl. CPC H02K 1/2791; H02K 1/02; H02K 2201/03

(57) ABSTRACT

A rotor for an electric machine includes a housing, a plurality of arc-shaped magnets disposed in the housing, and a plurality of separators interposed between the magnets. The magnets have a coercivity (Hci) of 2000 Oe (oersted) to 4000 Oe, and a magnetization direction of the magnets is in a circumferential orientation with respect to the housing.

### CROSS-REFERENCED TO RELATED APPLICATION

This application claims benefit of U.S. Provisional Patent Application No. 63/743,441, filed Jan. 9, 2025, and entitled PERMANENT MAGNET MOTORS WITH FLUX FOUNTAIN OUTRUNNER, the entire content of which is incorporated herein by reference.

### FIELD

The present disclosure relates generally to electric machines, and more specifically to electric machines implementing permanent magnets.

### BACKGROUND

Electric machines, such as electric motors and generators, typically use neodymium iron boron (NdFeB) magnets and other permanent magnet materials. Many electric machines use rare earth elements such as samarium cobalt (SmCo) and samarium iron nitride (SmFeN) magnets, as well as other strategic/critical minerals (such as cobalt in AlNiCo) whose supply may be limited and/or subject to disruption, resulting in unstable pricing and availability as well as poor sustainability and high greenhouse gas (GHG) footprint. Specifically, rare earth magnets are preferred because the extent to which rare-earth permanent magnet synchronous motors (PMSMs) can be flux-weakened is limited due to the high coercive force or intrinsic coercivity (Hci) of the rare earth magnets.

Efficiencies of externally excited electric machines, such as induction motors and direct-current (DC) brush motors, are significantly lower than those of PMSMs. Known electric machine designs that use AlNiCo, which are low-coercive-force (LCF) magnet, are also susceptible to demagnetization with high stator currents. When the motor control electronics or the winding of such electric machine designs experience a short-circuit failure condition, permanent magnet machines, especially generators, that implement such designs may have serious and potentially fatal safety issues. For example, when there is a continued generation of voltage, it causes an unconstrained flow of current through the machine, leading to machine failure and a hazardous safety condition, due to: (i) overheating of the machine due to the flow of eddy currents caused by the magnetic field of the spinning rotor, (ii) overheating of the machine due to unconstrained current flow in the coil windings, and/or (iii) high voltage on the motor housing, which should be at ground, due to the eddy currents caused by the magnetic field of the spinning rotor.

As such, there is a need for motors that do not use any rare earth metals or strategic/critical minerals, as well as a system that effectively controls operation of such motors to reduce the risk of failure caused by demagnetization as commonly found in known permanent magnet machines that do not use such rare earth metals or strategic/critical minerals.

### SUMMARY

Disclosed herein are rotors as implemented in electric machines, in which the rotor has a housing, arc-shaped magnets, and separators interposed between the magnets.

According to one example (“Example 1”), a rotor includes a housing, a plurality of arc-shaped magnets disposed in the housing, and a plurality of separators interposed between the magnets. The magnets have a coercivity (Hci) of 2000 Oe (oersted) to 4000 Oe, and a magnetization direction of the magnets is in a circumferential orientation with respect to the housing.

According to another example (“Example 2”) further to Example 1, the housing is formed of a nonferrous material, and a length of each of the magnets as measured in the magnetization direction is at least 10 times a thickness of the housing.

According to another example (“Example 3”) further to Example 2, the nonferrous material includes one or more of: aluminum, stainless steel, plastic, titanium, titanium alloy, magnesium, or magnesium alloy.

According to another example (“Example 4”) further to any one of Examples 1-3, the separators are formed of a ferrous alloy.

According to another example (“Example 5”) further to any one of Examples 1-4, the magnets maintain a magnetic flux density of at least 0.5 T (tesla) during operation.

According to another example (“Example 6”) further to any one of Examples 1-5, the magnets include iron nitride (FeN) magnets.

According to another example (“Example 7”) further to any one of Examples 1-6, the separators are arc-shaped.

According to another example (“Example 8”) further to Example 7, a total sum of arc angles of the separators and of the magnets equals 360 degrees.

According to another example (“Example 9”) further to Example 7, a number of the magnets equals a number of the separators.

According to another example (“Example 10”) further to Example 9, the magnets have an arc angle (θₘ), and the separators have an arc angle (θₛ) such that (θₘ+θₛ)*n=360, in degrees, where n is the number of the magnets in the rotor.

According to another example (“Example 11”) further to Example 9 or 10, the number of the magnets is eight (8).

According to another example (“Example 12”) further to any one of Examples 1-11, the separators are in direct contact with the magnets.

According to another example (“Example 13”) further to any one of Examples 1-12, magnetization directions of two neighboring magnets of the arc-shaped magnets are in opposite directions with respect to each other to facilitate alternating polarities.

According to another example (“Example 14”) further to any one of Examples 1-13, the magnets are formed using only non-strategic-mineral materials.

According to another example (“Example 15”) further to any one of Examples 1-13, the magnets are formed using only non-rare-earth-metal materials.

According to another example (“Example 16”) further to any one of Examples 1-15, the separators include steel poles.

According to another example (“Example 17”) further to any one of Examples 1-16, the magnetization direction of the magnets is in a transverse orientation with respect to a magnetic airgap of the rotor.

According to another example (“Example 18”), an electric machine includes the rotor of Example 17, and a stator disposed in the rotor. The magnetic airgap is located between the rotor and the stator.

According to another example (“Example 19”), a rotor includes a nonferrous housing, a plurality of arc-shaped FeN magnets disposed in the housing, and a plurality of ferrous separators interposed between the FeN magnets. A magnetization direction of the FeN magnets is in a circumferential orientation with respect to the housing.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1 shows an example of an electric machine system according to embodiments disclosed herein.

FIG. 2A shows an angled front view of an electric machine according to embodiments disclosed herein.

FIG. 2B shows an angled back view of an electric machine according to embodiments disclosed herein.

FIG. 3 (prior art) shows a cross-sectional view of an electric machine having magnets arranged in a radial orientation as known in the art.

FIG. 4 (prior art) is a magnetic flux plot map of a cross-sectional view of an electric machine having magnets arranged in a radial orientation as known in the art.

FIG. 5 (prior art) is a magnetic flux plot map of a cross-sectional view of an electric machine having magnets arranged in a radial orientation as known in the art.

FIG. 6 (prior art) is a magnetic flux plot map of a cross-sectional view of an electric machine having magnets arranged in a radial orientation as known in the art.

FIG. 7 shows a cross-sectional view of an electric machine having magnets arranged in a circumferential or transverse orientation according to embodiments disclosed herein.

FIGS. 8A through 8D are magnetic flux plot maps of a cross-sectional view of an electric machine having magnets arranged in a circumferential or transverse orientation with different arc angles for the magnets, according to embodiments disclosed herein.

FIG. 9 is a comparison graph that compares the airgap flux density measurements in different types of electric machines as known in the art and according to embodiments disclosed herein.

### DETAILED DESCRIPTION

The present disclosure is generally directed to electric machines implementing permanent magnets that do not include any rare earth metals or strategic/critical minerals. Various embodiments relate to electric machines that implement a rotor design referred to herein as a “flux fountain outrunner” that uses low coercive force (LCF) magnets, such as iron nitride (FeN) magnets. Various concepts also relate to a system or controller configured to enhance the functionality of such electric machines.

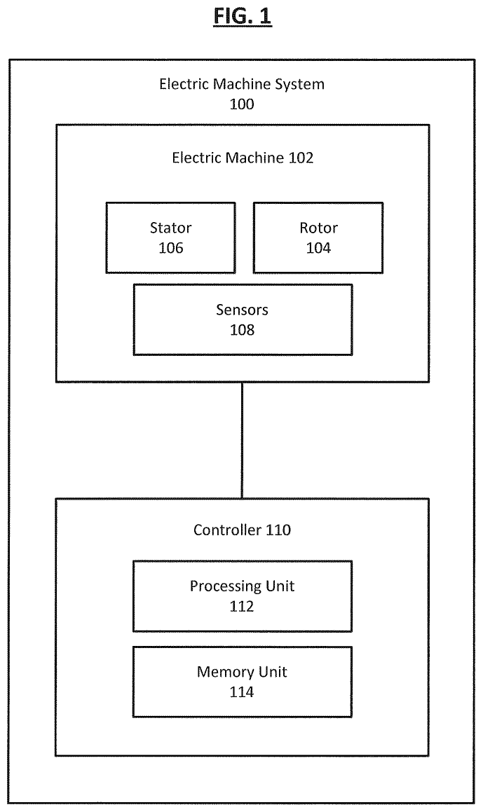

FIG. 1 is a schematic diagram of a system or electric machine system 100, according to some embodiments. The system 100 includes an electric machine 102, such as a motor or generator, for example, that comprises a rotor 104 and a stator 106, as well as one or more sensors 108 coupled to the rotor 104 and/or stator 106 to measure parameters associated with the rotor and/or stator, such as the magnetic field strength or magnetic flux density of the permanent magnets, the speed of rotation of the rotor, or the temperature of the motor, for example. In an outrunner design, the electric machine 102 is an electric motor with the rotor 104 disposed outside the stator 106.

The system 100 also includes a controller 110 operatively coupled with the electric machine 102 that is capable of controlling operation of the electric machine 102. The controller 110 may include at least one processing unit 112 such as a computer processor, and a memory unit 114 operatively coupled therewith. The memory unit 114 may be a non-transitory computer-readable medium storing computer readable instructions, which when executed by the processing unit, causes the processing unit to execute any one or more of the processes or algorithms as further disclosed herein. The one or more processes and/or algorithms may control the operation of the electric machine 102 based on inputs such as the sensor readings.

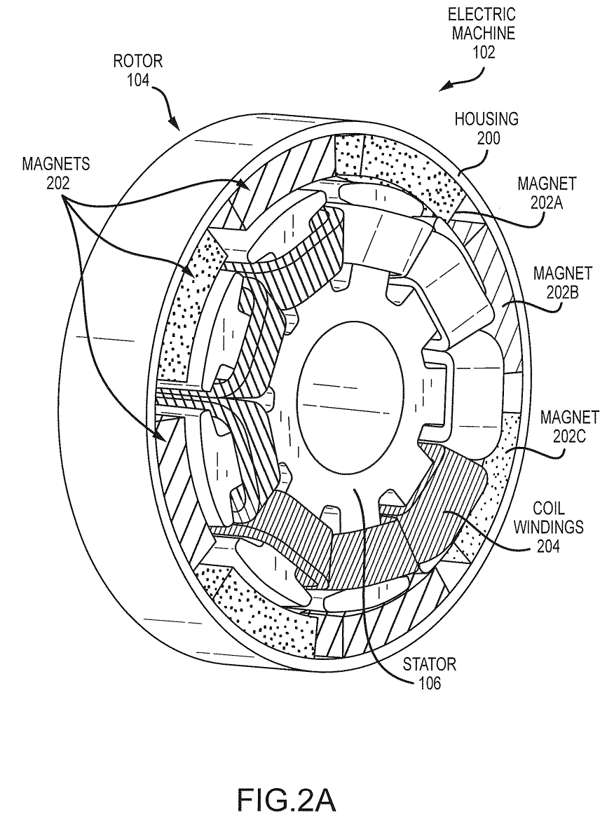

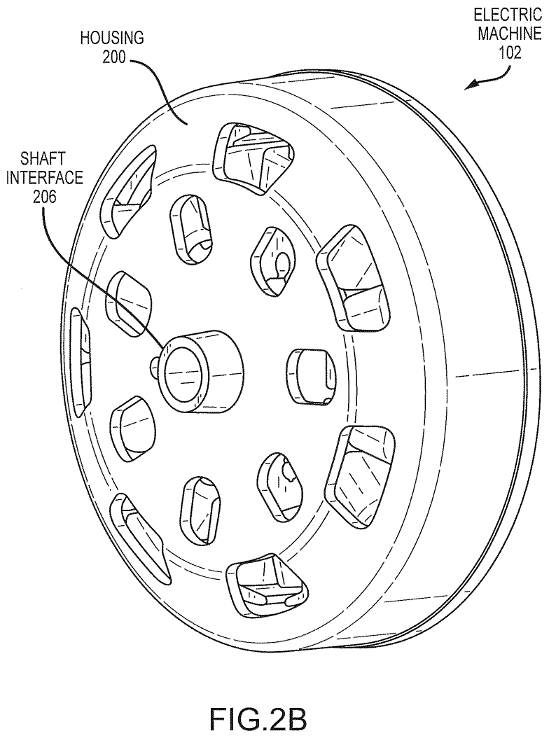

FIGS. 2A and 2B show an example of the electric machine 102, according to some embodiments. The electric machine 102 includes a housing 200 that defines the outer periphery of the rotor 104, with a plurality of magnets 202 disposed on an inner surface of the housing 200 so as to surround the stator 106. The electric machine 102 may be operable as a permanent magnet synchronous motor (PMSM). The stator 106 includes a plurality of coil windings 204. The housing 200 may be formed in the shape of a cup, and is made of any suitable material such as a nonferrous material. The magnets 202 are disposed so as to have a radial orientation of magnetization and have the shape of an arc, or an arcuate shape, as defined by a curvature in the shape of the magnets. The magnets 202 are arranged such that neighboring magnets have alternating polarity. For example, in FIG. 2A, the magnet 202A may have a first polarity, the magnet 202B adjacent to the magnet 202A may have a second polarity that is different from the first polarity, and the magnet 202C adjacent to the magnet 202B may have the first polarity. In FIG. 2B, the bottom portion of the cup-shaped housing has a shaft interface 206 extending from the outer surface, such that the shaft interface 206 may be connected to a shaft for rotating a secondary device. For example, the shaft may be attached to the wheels of a vehicle (not shown).

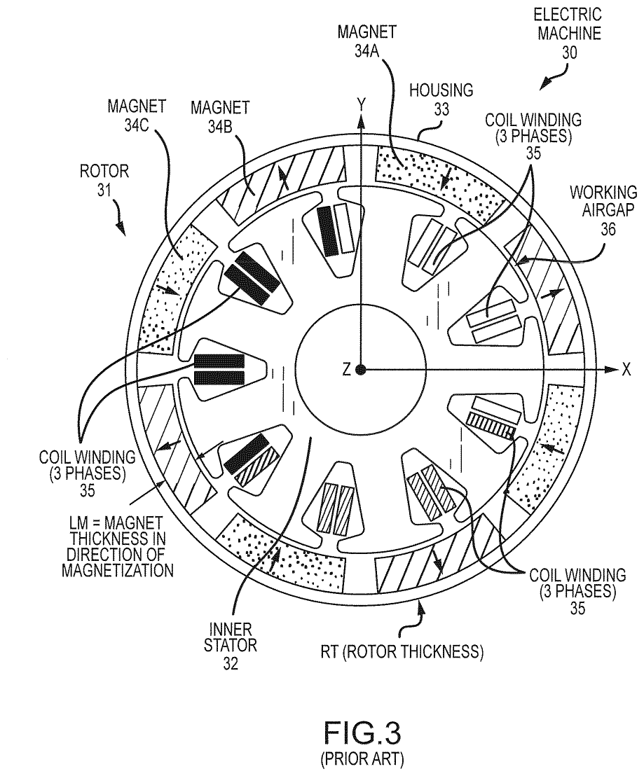

FIGS. 3 through 6 show prior art electric machines 30, 40, 50, 60 during operation. As shown, each of the electric machines 30, 40, 50, 60 is a commonly used 8-pole 9-slot outrunner PMSM.

The coil windings 35 are arranged to form a three-phase electric machine 30, 40, 50, 60, and the magnetization of the magnets 34 is in a radial orientation. That is, the magnetization is directed either inwardly toward the center of the electric machine 30, 40, 50, 60 or radiating outwardly from the center of the electric machine 30, 40, 50, 60, as shown by the arrows superimposed on the arc-shaped magnets 34 in FIG. 3. The magnet length is labeled as “Lm” and is defined as the length measured in the direction of magnetization. The rotor thickness is labeled as “RT” and is defined as the sum of the magnet length (Lm) and the thickness of the outer housing 33 measured from the inner surface (at which the magnets are disposed) to the outer surface. The rotor 31 and the stator 32 are separated by an airgap 36. In such motors, the depth of the rotor and stator are variable and scalable, such that a series of motors of increasing depth, which yield increasing performance, can be designed with an identical cross section. For example, regarding the scaling of the rotor and stator, the following rules apply to how increasing the axial length of a radial flux motor would affect other properties of the motor: (a) the amount of torque is linearly proportional to the axial length of the motor; (b) the amount of resistance is linearly proportional to the axial length; and (c) the motor constant is inversely correlated to the square root of the axial length according to the relationship expressed by Equation 1 in which Km is the motor constant, Kt is the torque constant, and R is the axial length.

$${K}_{m} = \frac{{K}_{t}}{\sqrt{R}} \qquad ( Equation 1 )$$

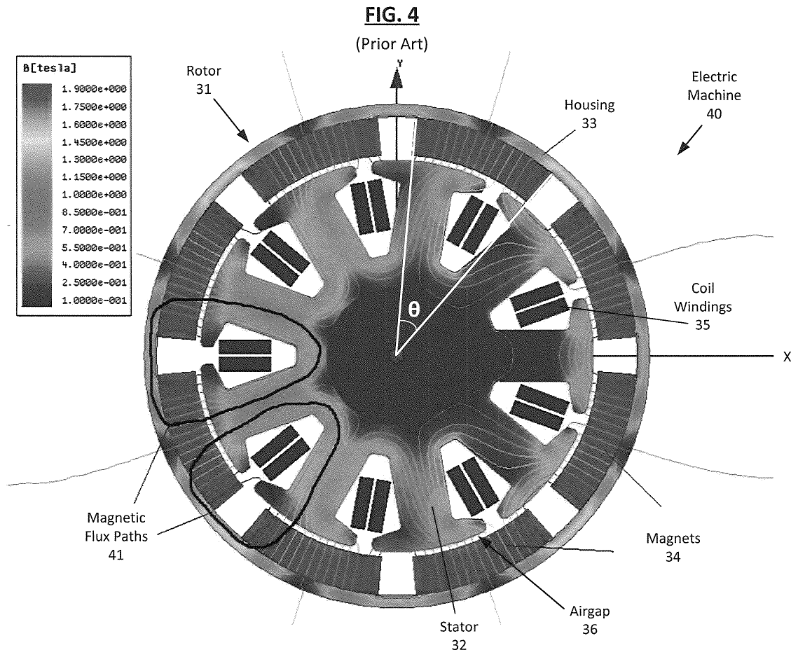

FIG. 4 shows another prior art electric machine 40 in an outrunner PMSM with ferrite magnets. Ceramic or ferrite magnets have a coercive force in the range of about 2500-4000 oersted (Oe), or about 200-320 kA/m. The arc-shaped magnets 34 define an arc angle (θ) as measured with respect to the center of the electric machine 40. In the electric machine 40, the housing 33 is made of Cold Rolled Steel (CRS) SAE type 1010 metal. As shown, there are eight magnet poles and eight flux paths, with the magnets 34 formed as eight sintered ceramic/ferrite magnet arcs with magnetization in a radial orientation and having alternating polarity, each of the magnetic flux paths 41 passes around the coil windings 35 and through the stator 32, the magnets 34, and the rotor 31 as shown in the bolded line, and the magnets 34 are thicker than the outer housing 33, which is necessary in order to close the magnetic flux paths. As such, the magnet thickness Lm as shown defines three-fourths (75%) of the rotor thickness RT. In FIG. 4 all the magnets 34 in the electric machine 40 have low magnetization or magnetic flux density (around 0.4 tesla, or 0.4 T), resulting in poor motor performance of the PMSM, while higher magnetization (around 0.7 T) is observed in the stator 32 surrounding the magnetic flux paths 41.

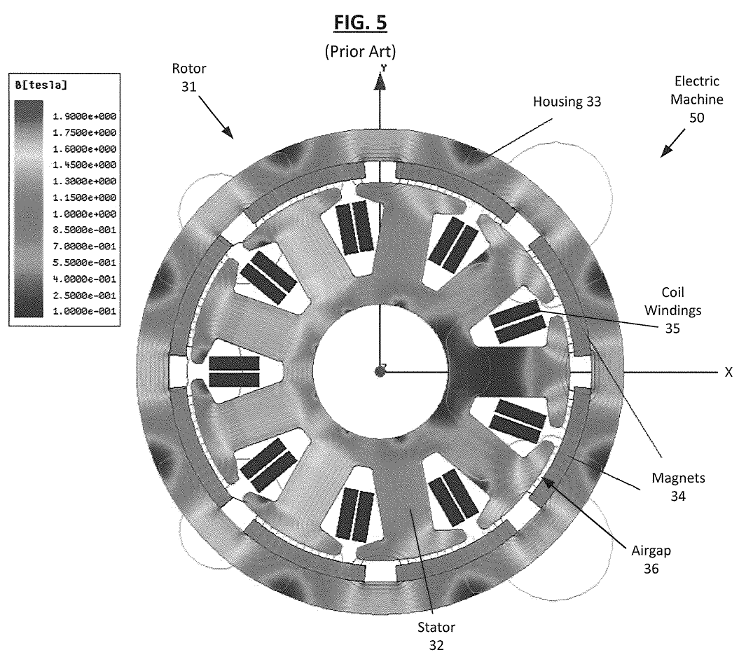

FIG. 5 shows another prior art electric machine 50 in an outrunner PMSM with neodymium iron boron (NdFeB) magnets. NdFeB magnets have a coercive force in the range of about 10,000-12,000 oersted (Oe), or about 800-950 kA/m. The magnets 34 in electric machine 50 are N42SH sintered NdFeB magnet arcs with magnetization in a radial or parallel orientation and having alternating polarity, and the magnets 34 are disposed in the outer housing 33 that is thicker than the magnets 34, which is necessary in order to close the magnetic flux paths. As such, the magnet thickness Lm as shown defines one-third (33%) of the rotor thickness RT. The magnets 34 have higher magnetization or magnetic flux density than in FIG. 4 (between 0.7 T and 1.2 T), resulting in better motor performance.

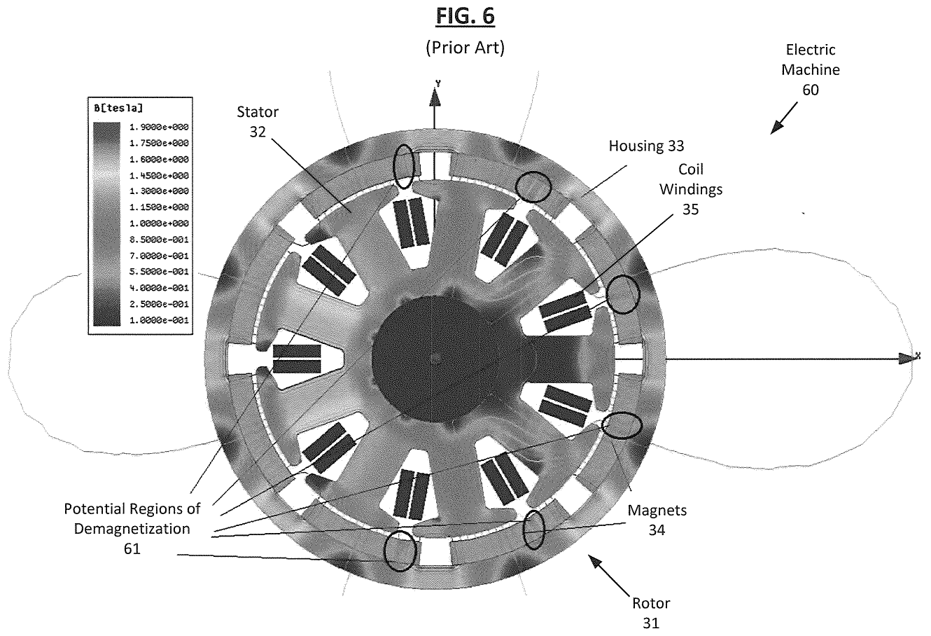

FIG. 6 shows another electric machine 60 in an outrunner PMSM with FeN magnets, as known in the art. The FeN magnets are LCF magnets, showing regions of demagnetization 61. The regions 61 are marked in circles, showing portions of the magnets 34, which are formed in an arc-shape with magnetization in a radial or parallel orientation and having alternating polarity, with lower magnetic flux density, which may be defined as being less than 0.5 T. Because the magnet thickness Lm of the magnets 34 is limited by the radial distance between an inner surface of the outer rotor 31 and an outer surface of the inner stator 32, the FeN magnets with low coercive force are prone to demagnetization in regions 61 as shown. As shown, the magnet thickness Lm defines one-half (50%) of the rotor thickness RT. As such, although having better motor performance than the ferrite magnet motor of FIG. 4, the FeN magnet motor of FIG. 6 still has poorer motor performance as compared to the NdFeB magnet motor of FIG. 5.

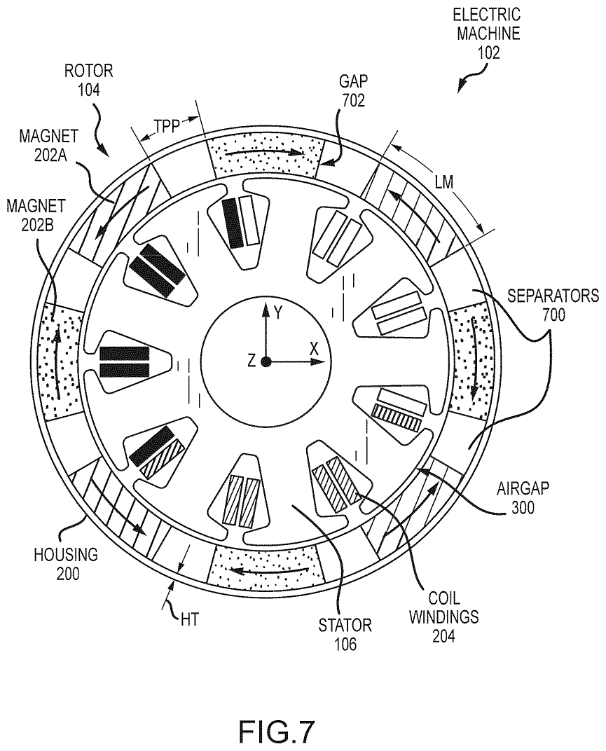

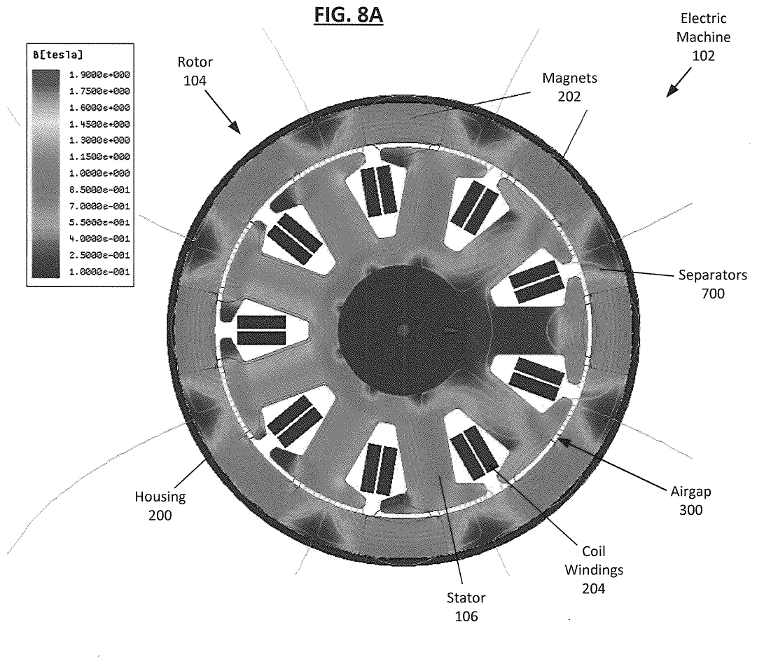

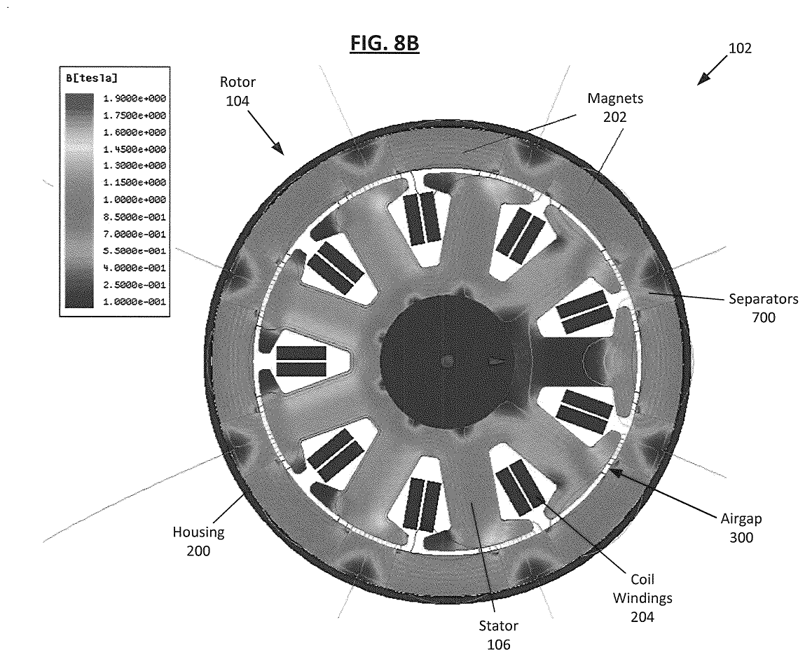

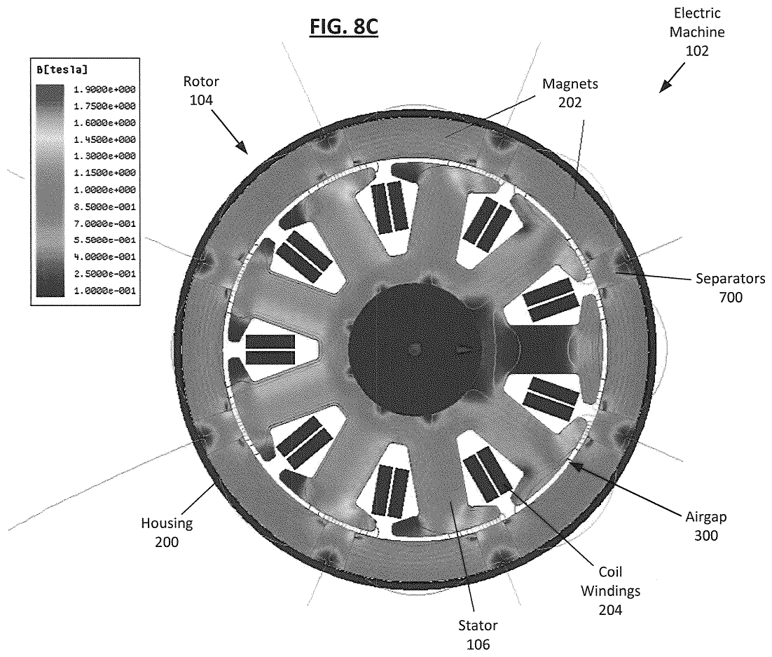

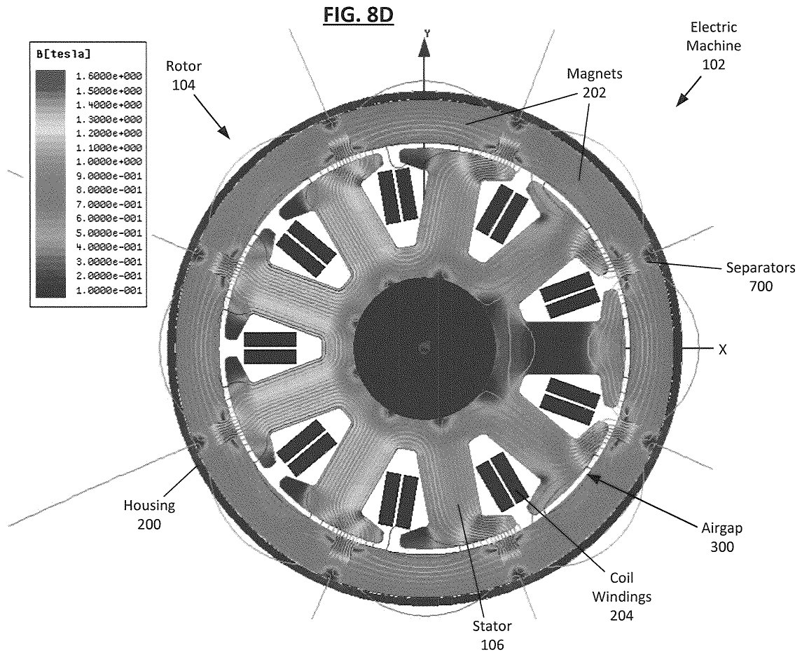

FIGS. 7 and 8A through 8D illustrate embodiments of electric machine 102 as disclosed herein. FIG. 7 shows an example of the electric machine 102, which can be contrasted to the prior art electric machines of FIGS. 3-6, according to embodiments disclosed herein. In the electric machine 102, which is an outrunner PMSM having an 8-pole embodiment, the magnets 202 are FeN magnets with a low coercive force of 2000-4000 oersted (Oe), or 159.2-318.3 kA/m. The magnets 202 are formed in an arc shape with magnetization in either a circumferential or transverse orientation, as shown by the bolded arrows, which may be in the direction along the arc of the magnets 202. For example, the neighboring magnets 202A and 202B have magnetization orientations in opposite directions from each other to facilitate alternating polarities. Because the magnet length “Lm” is defined as the length measured in the direction of magnetization, the magnet length Lm of the magnet 202 is equivalent to the arc length of the magnet. In some examples, the magnet length Lm of the magnet 202 may be 10 times, 15 times, 20 times, 25 times, 30 times, or any other suitable value within the foregoing ranges or any other suitable range between any of the foregoing ranges, of the housing thickness (labeled as “HT” in FIG. 7) of the housing 200. In some examples, the magnets 202 as disclosed herein are formed using only non-strategic-mineral materials and/or non-rare-earth-metal materials.

Disposed between neighboring magnets are separators 700 which may be made from a ferrous alloy such as a ferrous steel alloy (e.g., steel poles, also referred to as ferrous separators), with a length or thickness of the poles, labeled as “Tpp”, measured between the ends of the neighboring magnets 202, such that the separators 700 are interposed between the magnets 202. The length or thickness Tpp may also be referred to as a radial length or an arc angle when the separators 700 are also formed in an arc shape, similar to the magnets 202. In some examples, the thickness Tpp of the separator 700 may be 10-20%, 20-30%, 30-40%, 40-50%, 50-60%, 60-70%, 70-80%, 80-90%, or any other suitable value within the foregoing ranges or any other suitable range between any of the foregoing ranges, of the magnet length Lm of the magnet 202. The magnets 202 and the separators 700 are disposed in an interleaving configuration with respect to each other, and the magnets 202 and the separators 700 are in direct contact with each other (that is, the separators 700 are in direct contact with the neighboring magnets 202) with minimal airgaps in between, in order to minimize unwanted high-reluctance interruptions in the magnetic flux paths. In some examples, a total of all gaps 702 between the separators 700 and the magnets 202 may be no greater than 20 arc degrees, no greater than 10 arc degrees, no greater than 5 arc degrees, no greater than 1 arc degree, or any other suitable value within the foregoing ranges or any other suitable range between any of the foregoing ranges. When the total of all gaps 702 equals 0 arc degree, then the separators 700 and the magnets 202 are in direct contact with each other. In some examples, the total of all gaps 702 equaling 0 arc degree may be considered an ideal condition for operation.

The outer housing 200 is made of any suitable nonferrous material to form a nonferrous housing, including but not limited to: aluminum, stainless steel (e.g., austenitic non-magnetic stainless steel and 300-series nonmagnetic stainless steel), plastic, titanium and its alloys (e.g., titanium-magnesium alloys and titanium-aluminum alloys), and/or magnesium and its alloys (e.g., in combination with aluminum or zinc), for example. The currentless nature of the nonferrous housing facilitates reduction of the amount of voltage in the housing to a low level, thereby reducing the risk of the electric machine overheating due to the flow of eddy currents caused by the magnetic field of the spinning rotor or due to unconstrained current flow in the coil windings. In some examples, the low level of voltage may be less than 20 volts, less than 15 volts, less than 10 volts, less than 5 volts, or any other suitable value within the foregoing ranges or any other suitable range between any of the foregoing ranges, including 0 volts. For example, the low voltage (or no voltage) detected in the nonferrous housing results in the induced current to be at or near 0 amperes, and the eddy currents resulting from the magnetic field induced by the non-spinning motor may be at or near 0 amperes, hence causing little to no current-induced heat being added to the electric machine. The plastic material that is used may be any suitable polymeric material with a high melting point above the maximum operating temperature of the motor, such as above 150 degrees Celsius, above 200 degrees Celsius, above 250 degrees Celsius, above 300 degrees Celsius, or any other suitable value within the foregoing ranges or any other suitable range between any of the foregoing ranges. Nonlimiting examples of the plastic material include polypropylene, polycarbonate, polyether ether ketone, polyetherimide, and polybenzimidazole.

FIGS. 8A through 8D show the different magnetic flux plots of the outrunner PMSM, that is, the electric machine 102 of FIG. 7, using different arc angles (θ) for the magnets 202. For example, in FIG. 8A, each of the eight magnets 202 in the electric machine 102 has an arc angle θ of 22.5 degrees. In this example, the arc angle of each of the eight magnets 202 equals the arc angle of each of the eight separators 700, such that the sum of all arc angles is 360 degrees. In FIG. 8B, the arc angle θ of each of the eight magnets 202 is 30 degrees, such that the arc angle of each of the eight separators 700 is 15 degrees. In FIG. 8C, the arc angle θ of each of the eight magnets 202 is 36 degrees, such that the arc angle of each of the eight separators 700 is 9 degrees. In FIG. 8D, the arc angle θ of each of the eight magnets 202 is 40 degrees, such that the arc angle of each of the eight separators 700 is 5 degrees.

The following formula (Equation 2) shows the relationship between the arc angle (θₛ) of each separator 700, in degrees, the arc angle (θₘ) of each magnet 202, in degrees, and the pole number (n):

$$( {θ}_{m} + {θ}_{s} ) * n = 360 \qquad ( Equation 2 )$$

Regarding Equation 2, the arc angle (θₛ) of each separator 700 may also be referred to as the pole length or thickness (Tpp), and the arc angle (θₘ) of each magnet 202 may also be referred to as the magnet length (Lm).

As can be observed in FIGS. 8A through 8D, the magnets 202 maintain a predetermined magnetic flux density during the operation of the electric machine 102, and the predetermined magnetic flux density may be at or above 0.5 T, at or above 0.6 T, at or above 0.7 T, at or above 0.8 T, at or above 0.9 T, at or above 1.0 T, at or above 2.0 T, at or above 3.0 T, or any other suitable value within the foregoing ranges or any other suitable range between any of the foregoing ranges. In the embodiments shown in FIGS. 7 and 8A through 8D, the electric machine 102 is referred to as a “flux fountain” outrunner PMSM.

Referring back to the prior-art electric machine 30, a typical outrunner PMSM as shown in FIG. 3, and as known in the art, has a primary flux path which starts in the magnet 34A, jumps across a working air gap 36 (i.e., the airgap located between the magnets 34 and the inner stator 32), passes through the stator 32, jumps back across the working air gap 36, passing back through the adjacent magnet 34B, and closes the flux path loop through the ferrous outer housing 33. Some of the magnetic flux paths 41 are also shown in the typical outrunner PMSM of FIG. 4, also known in the art.

Furthermore, in the typical outrunner PMSM, the maximum arc angle (θₘₐₓ) of the magnets 34, in degrees, is calculated based on the number of magnet poles (n) using the following Equation 3:

$${θ}_{m ax} = \frac{360}{n} \qquad ( Equation 3 )$$

Generally, in practice, the arc angle (θ) of each magnet 34 in such typical outrunner PMSM is in the range of 65%-90% of the maximum arc angle (θₘₐₓ).

Also, in the rotor of a typical outrunner PMSM, the working magnet thickness (Lm), which is measured along the direction of magnetization as explained above, is limited by the need for a ferrous steel flux return on the outer diameter of the magnetic circuit. In a typical 8-pole, 9-slot motor geometry with an outer diameter of a fixed rotor and an outer diameter of a fixed stator and lamination, the outrunner PMSM of FIG. 6 uses eight arc-shaped FeN magnets 34, arranged such that magnetization of the magnets is in the radial direction, which is either toward or away from the center of the PMSM. Therefore, the working magnet thickness (Lm) in the prior-art outrunner PMSM is limited by the distance between an inner surface of the housing 200 and an outer surface of the stator 32, which is where the magnets 34 can be positioned. The reduced thickness causes potential regions of demagnetization to be formed in at least a portion of the magnets 34, as shown in FIG. 6.

In contrast to the prior-art electric machines 30, 40, 50, 60 of FIGS. 3-6, embodiments of the electric machine 102 as disclosed herein, shown in FIGS. 7 and 8A through 8D, for example, implement the magnets 202 to be oriented such that magnetization of the magnets 202 is in the transverse direction with respect to a magnetic airgap 300 between the magnets 202 and the stator 106, either with a straight-through (transverse) orientation or a circumferential orientation, that is, in a direction perpendicular to the magnet orientation of a standard outrunner PMSM as shown in FIGS. 3 through 6. The magnet 202 may be a single unitary magnet (e.g., formed of a single piece of material) or a plurality of magnets attached together to form a combined magnet that operates as a single magnet. Each magnet (e.g., 202A) is of opposing polarity to the adjacent magnet (e.g., 202B), so that the North pole of each magnet is facing the North pole of the adjacent magnet, and the South pole of each magnet is facing the South pole of the adjacent magnet. Also, each magnet is separated by a separator 700 which may be a ferrous alloy such as a steel pole piece, or a nickel (or nickel alloy) pole piece. The magnetic flux from adjacent magnets (either two North poles or two South poles) feeds into the steel pole piece separator 700, and a majority of this flux (e.g., at least 55%, at least 60%, at least 65%, at least 70%, at least 75%, at least 80%, or any other suitable value within the foregoing ranges or any other suitable range between any of the foregoing ranges) then flows into the laminations of the stator 106, creating the useful torque-producing electromagnetic interaction between the rotor 104 and the stator 106.

The “flux fountain” rotor design for outrunner PMSM as disclosed herein allows for the use of magnets with low coercive force, which may be within the range of 2000-4000 Oe (159.2-318.3 kA/m), such as 2000-2500 Oe (159.2-198.9 kA/m), 2500-3000 Oe (198.9-238.7 kA/m), 3000-3500 Oe (238.7-278.5 kA/m), 3500-4000 Oe (278.5-318.3 kA/m), or any other suitable value within the foregoing ranges or any other suitable range between any of the foregoing ranges, while still providing equal or better motor performance in comparison to existing outrunner PMSMs that use ferrite magnets (as shown in FIG. 4) and providing comparable performance to existing outrunner PMSMs that use rare earth magnets (as shown in FIG. 5 which uses NdFeB magnets). The “flux fountain” rotor design also mitigates the risk of demagnetization of the LCF magnets during maximum current operation, due to the higher load line operating point (permeance coefficient) of such design. For example, the magnets may experience different magnetization states during operation, with each magnetization state having a different magnetic flux density (B)/magnetic field intensity (H) curves represented by a different percentage of magnetization. The magnetization state of the magnets controls the magnet flux linkage and the back (or counter) electromotive force (EMF) voltage of the motor. The load line operating point is the specific point on a magnet's B-H curve where the load line (a straight line with a slope equal to the permeance coefficient) intersects the curve, representing the operating point of the magnet within a magnetic circuit. Thus, the load line operating point indicates the magnetic flux density (B) and magnetic field strength (H) at which the magnet will function under given operating conditions and surrounding magnetic environment. The “flux fountain” rotor design also allows for adjustable back electromotive force (EMF), total flux, and maximum torque by adjusting the ratio of the magnet length (Lm) to the pole piece thickness (Tpp) as shown in FIGS. 8A through 8D. For example, increasing the magnet length Lm and decreasing the pole piece thickness Tpp in the rotor 104 (while maintaining the same number of magnets 202 and separators 700) may facilitate an increase in the total flux or maximum torque of the electric machine 102 that uses the rotor 104.

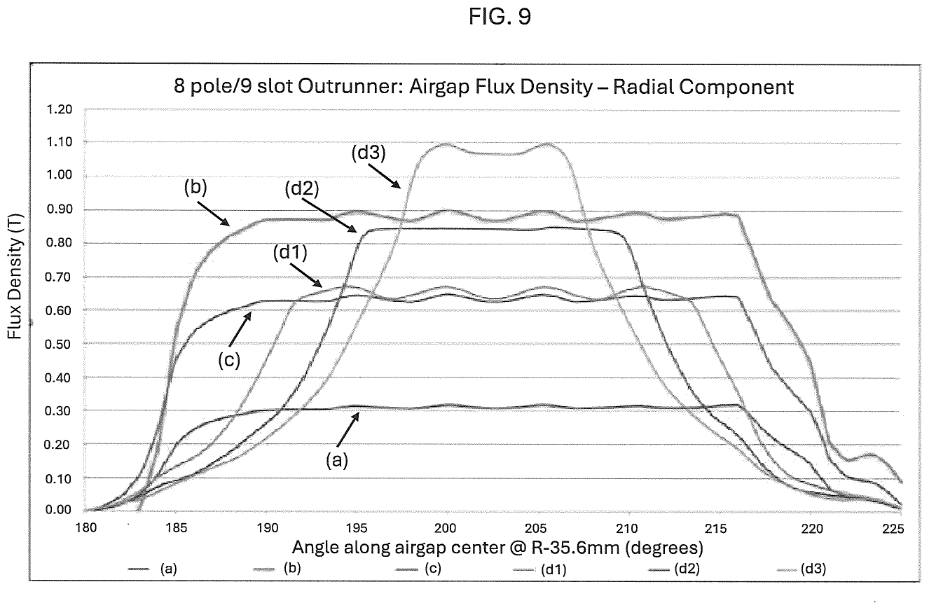

FIG. 9 compares the magnetic flux density values of each type of rotor design as explained herein. Measurements are taken for (a) ferrite magnet design, (b) NdFeB magnet design, (c) FeN magnet radial design, and (d) FeN magnet “flux fountain” design with three different arc angles for the magnets. The (a) ferrite magnet design is the prior-art example shown in FIG. 4; the (b) NdFeB magnet design is the prior-art example shown in FIG. 5; and the (c) FeN magnet radial design is the prior-art example shown in FIG. 6. The (d) FeN magnet “flux fountain” design is measured using the arc angles of (d1) 22.5 degrees which is the example shown in FIG. 8A, (d2) 30 degrees which is the example shown in FIG. 8B, and (d3) 36 degrees which is the example shown in FIG. 8C. In each of the examples, the motor has the 8-pole 9-slot motor geometry, for consistence. However, any other suitable motor geometry may be implemented as well, including for example 8-pole 12-slot geometry, 10-pole 12-slot geometry, 14-pole 12-slot geometry, or 14-pole 15-slot geometry, based on the type of motor that is to be implemented.

As shown in FIG. 9, the highest flux density (1.1 T) is achieved by the (d3) design of the FeN magnet “flux fountain” design using the arc angle of 36 degrees for each magnet. The (b) and (d2) designs achieve similar flux density of up to between 0.8 T and 0.9 T, and the (c) and (d1) designs achieve similar flux density of up to between 0.6 T and 0.7 T, during operation. Therefore, the (d2) design of the FeN magnet “flux fountain” design using the arc angle of 30 degrees for each magnet is comparable to the prior-art (b) NdFeB magnet design, and the (d1) design of the FeN magnet “flux fountain” design using the arc angle of 22.5 degrees for each magnet is comparable to the prior-art (c) FeN magnet radial design, with the (a) ferrite magnet design achieving the lowest flux density of only up to about 0.3 T.

Furthermore, the PMSMs with the “flux fountain” design that only use LCF magnets provide additional benefit of not requiring the use of any rare earth magnet while still maintaining high efficiency and high torque density comparable to the PMSMs that use such rare earth magnets. Avoiding the use of any rare earth elements or strategic elements allows the manufacturers of such PMSMs to not be affected by supply chain disruptions caused by dominance of the market by one or a few entities, as well as improving sustainability and lowering the greenhouse gas (GHG) footprint.

As explained above, another problem with a typical radial-magnet outrunner PMSM (see, for example, the electric machine 60 of FIG. 6 as known in the art) is that the annular thickness of the rotor is limited by the need for a ferrous outer housing to be used as a “back iron” in order to complete the magnetic circuit. The resulting radially-oriented magnets in the prior art designs shown are generally too thin in the direction of magnetization to allow for a robust motor design with a LCF magnet such as FeN magnet, thereby being prone to demagnetization.

In comparison, the “flux fountain” design that uses the same LCF magnets as disclosed herein facilitates circumferential or transverse magnetization (with respect to the airgap) of the magnetic circuit, thereby facilitating the use of the LCF magnets while mitigating the potential for demagnetization that is prone to the typical radial-magnet outrunner PMSM that implements the LCF magnets. The “flux fountain” design also has the potential to radially reduce the size of the rotor, because there is no need for a ferrous outer ring that is thick enough to carry the magnetic flux of the rotor, as is required in the PMSM of FIG. 5 as known in the art. Therefore, in some examples, the housing thickness HT of the housing 200 may define no more than 20%, no more than 15%, no more than 10%, no more than 5%, or any other suitable value within the foregoing ranges or any other suitable range between any of the foregoing ranges, of the rotor thickness RT.

Also, because the outer housing of the rotor in the “flux fountain” design is nonferrous, any material selected from a much wider variety of materials may be employed as the material of the rotor housing (as compared to an outer housing that must be ferrous, resulting in the list of potential materials to be narrower). In addition, the thickness of the outer housing is limited only by the mechanical strength of the material.

Numerous characteristics and advantages have been set forth in the preceding description, including various alternatives together with details of the structure and function of the devices and/or methods. Moreover, the scope of the various concepts addressed in this disclosure has been described both generically and with regard to specific examples. The disclosure is intended as illustrative only and as such is not intended to be exhaustive. It will be evident to those skilled in the art that various modifications may be made, especially in matters of structure, materials, elements, components, shape, size, and arrangement of parts including combinations within the principles of the disclosure, to the full extent indicated by the broad, general meaning of the terms in which the appended claims are expressed. To the extent that these various modifications do not depart from the spirit and scope of the appended claims, they are intended to be encompassed therein.

What is claimed is:

1. A rotor comprising:
a housing;
a plurality of arc-shaped magnets disposed in the housing, wherein:
the magnets have a coercivity (Hci) of 2000 Oe (oersted) to 4000 Oe; and
a magnetization direction of the magnets is in a circumferential orientation with respect to the housing; and
a plurality of separators interposed between the magnets.

2. The rotor of claim 1, wherein the housing is formed of a nonferrous material, and a length of each of the magnets as measured in the magnetization direction is at least 10 times a thickness of the housing.

3. The rotor of claim 2, wherein the nonferrous material includes one or more of: aluminum, stainless steel, plastic, titanium, titanium alloy, magnesium, or magnesium alloy.

4. The rotor of claim 1, wherein the separators are formed of a ferrous alloy.

5. The rotor of claim 1, wherein the magnets maintain a magnetic flux density of at least 0.5 T (tesla) during operation.

6. The rotor of claim 1, wherein the magnets include iron nitride (FeN) magnets.

7. The rotor of claim 1, wherein the separators are arc-shaped.

8. The rotor of claim 7, wherein a total sum of arc angles of the separators and of the magnets equals 360 degrees.

9. The rotor of claim 7, wherein a number of the magnets equals a number of the separators.

10. The rotor of claim 9, wherein the magnets have an arc angle (θₘ), and the separators have an arc angle (θₛ) such that (θₘ+θₛ)*n=360, in degrees, where n is the number of the magnets in the rotor.

11. The rotor of claim 9, wherein the number of the magnets is eight (8).

12. The rotor of claim 1, wherein the separators are in direct contact with the magnets.

13. The rotor of claim 1, wherein magnetization directions of two neighboring magnets of the arc-shaped magnets are in opposite directions with respect to each other to facilitate alternating polarities.

14. The rotor of claim 1, wherein the magnets are formed using only non-strategic-mineral materials.

15. The rotor of claim 1, wherein the magnets are formed using only non-rare-earth-metal materials.

16. The rotor of claim 1, wherein the separators include steel poles.

17. The rotor of claim 1, wherein the magnetization direction of the magnets is in a transverse orientation with respect to a magnetic airgap of the rotor.

18. An electric machine comprising:
the rotor of claim 17; and
a stator disposed in the rotor, wherein the magnetic airgap is located between the rotor and the stator.

19. A rotor comprising:
a nonferrous housing;
a plurality of arc-shaped iron nitride (FeN) magnets disposed in the housing, wherein a magnetization direction of the FeN magnets is in a circumferential orientation with respect to the housing; and
a plurality of ferrous separators interposed between the FeN magnets.
